(19) United States
(12) Patent Application Publication
(10) Pub. No.: US 2019/0391908 A1
(43) Pub. Date: Dec. 26, 2019

(54) METHODS AND DEVICES FOR INTELLIGENT SELECTION OF CHANNEL INTERFACES

(71) Applicant: CA, Inc., New York, NY (US)

(72) Inventors: Madhusudhan GANDA, Kadapa (IN); Vikrant NANDAKUMAR, Bangalore (IN); Kiran KUMAR B.S., Bangalore (IN); Badrinath MOHAN, Bangalore (IN)

(21) Appl. No.: 16/015,725

(22) Filed: Jun. 22, 2018

(51) Int. Cl. G06F 11/36

(52) U.S. Cl. CPC G06F 11/3684; G06F 11/3664; G06F 11/3688

(57) ABSTRACT

A method includes performing, by a processor, identifying a first interface associated with a first functionality of a plurality of functionalities of an application, where a portion of the first functionality has changed within the application, identifying a second functionality of the plurality of functionalities of the application that has not changed, where the second functionality is associated with a plurality of second interfaces, selecting a testing interface out of the plurality of second interfaces associated with the second functionality, and executing a test case for testing the application using the first interface associated with the first functionality and using the testing interface associated with the second functionality, but refraining from using remaining ones of the second interfaces associated with the second functionality for executing the test case.

### BACKGROUND

The ubiquitous presence of Internet connected devices worldwide has led to an era governed by applications. Increasing aspects of personal, social and professional lives are governed by applications. Communication may occur through social apps, cinema tickets may be booked using mobile or other connected devices, and trips may be scheduled using airline and/or hotel websites. The digitization of most aspects of daily life has spurred businesses, companies, and/or organizations to rapidly develop applications for providing features and access for the convenience of consumers. Consumers expect to receive services from businesses from various channels of their choice, such as via voice, email, Short Message Service (SMS)/text, World Wide Web, mobile platforms, or through social media.

### SUMMARY

Various embodiments of the present inventive concept are directed to a method including performing operations as follows on a processor. The operations include identifying a first interface associated with a first functionality of a plurality of functionalities of an application, where a portion of the first functionality has changed within the application, identifying a second functionality of the plurality of functionalities of the application that has not changed, where the second functionality is associated with a plurality of second interfaces, selecting a testing interface out of the plurality of second interfaces associated with the second functionality, and executing a test case for testing the application using the first interface associated with the first functionality and using the testing interface associated with the second functionality, but refraining from using remaining ones of the plurality of second interfaces associated with the second functionality for executing the test case. In some embodiments, selecting the testing interface includes dynamically selecting the testing interface during the executing the test case for testing the application.

In some embodiments, operations performed on the processor may include identifying a plurality of third interfaces associated with the first functionality, and executing the test case over each of the plurality of the third interfaces. Selecting the testing interface out of the plurality of second interfaces associated with the second functionality may include selecting the testing interface based on a ranking of use of the testing interface during previous execution of the application. Selecting the testing interface out of the plurality of second interfaces associated with the second functionality may include selecting the testing interface based on reliability of the testing interface across a plurality of previous executions of the test case. Selecting the testing interface out of the plurality of second interfaces associated with the second functionality may include selecting the testing interface based on performance analytics of the test interface over a period of time. Selecting the testing interface out of the plurality of second interfaces associated with the second functionality may include selecting the testing interface based on a previous test execution time.

In some embodiments, operations performed on the processor may include identifying the first functionality for which the portion of the first functionality has been changed within the application based on a code management tool or a defect management tool. Selecting the testing interface out of the plurality of second interfaces associated with the second functionality may include generating a graph including a plurality of nodes representing respective states of the application and a plurality of edges representing respective ones of the plurality of functionalities of the application, and selecting the testing interface of the second functionality based on a weight of an edge associated with the second functionality. A transition between a first node and a second node of the plurality of nodes may be associated with the second functionality, and the transition may include a plurality of edges associated with respective ones of the plurality of second interfaces associated with the second functionality.

In some embodiments, operations performed on the processor may include determining respective weights of respective ones of the plurality of edges between the first node and the second node. Selecting the testing interface of the second functionality may include selecting the testing interface associated with the highest weight of the respective weights that were determined. A first weight of the respective weights includes a sum of respective contribution factors associated with respective ones of a plurality of attributes. The plurality of attributes may include performance, scalability, and/or reliability. Selecting the testing interface of the second functionality based on the weight of an edge associated with the second functionality may include selecting the testing interface during the executing the test case for testing the application.

Various embodiments of the present inventive concept include a computer program product, that includes a tangible non-transitory computer readable storage medium storing computer readable program code which when executed by a processor of an electronic device causes the processor to perform operations as follows on a processor. The computer readable program code includes computer readable code to identify a first interface associated with a first functionality of a plurality of functionalities of an application, where a portion of the first functionality has changed within the application, computer readable code to identify a second functionality of the plurality of functionalities of the application that has not changed, where the second functionality is associated with a plurality of second interfaces, computer readable code select a testing interface out of the plurality of second interfaces associated with the second functionality, and computer readable code to execute a test case for testing the application using the first interface associated with the first functionality and using the testing interface associated with the second functionality, but refraining from using remaining ones of the plurality of second interfaces associated with the second functionality for executing the test case.

In some embodiments, the computer program product may include computer readable code to dynamically select the testing interface during the executing the test case for testing the application. The computer program product may include computer readable code to generate a graph comprising a plurality of nodes representing respective states of the application and a plurality of edges representing respective ones of the plurality of functionalities of the application and computer readable code to select the testing interface of the second functionality based on a weight of an edge associated with the second functionality. A transition between a first node and a second node of the plurality of nodes may be associated with the second functionality. The transition may include a plurality of edges associated with respective ones of the plurality of second interfaces associated with the second functionality. The computer program product may include computer readable code to determine respective weights of respective ones of the plurality of edges between the first node and the second node and computer readable code to select the testing interface associated with the highest weight of the respective weights that were determined.

Various embodiments of the present inventive concept include an computer system, including a processor, and a memory coupled to the processor and including computer readable program code embodied in the memory that when executed by the processor causes the processor to perform operations as follows on a processor. The operations include identifying a first interface associated with a first functionality of a plurality of functionalities of an application, where a portion of the first functionality has changed within the application, identifying a second functionality of the plurality of functionalities of the application that has not changed, where the second functionality is associated with a plurality of second interfaces, selecting a testing interface out of the plurality of second interfaces associated with the second functionality, and executing a test case for testing the application using the first interface associated with the first functionality and using the testing interface associated with the second functionality, but refraining from using remaining ones of the plurality of second interfaces associated with the second functionality for executing the test case. In some embodiments, selecting the testing interface includes dynamically selecting the testing interface during the executing the test case for testing the application.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Features of embodiments will be more readily understood from the following detailed description of specific embodiments thereof when read in conjunction with the accompanying drawings, in which:

FIG. 1 illustrates an omni-channel communication network for providing services over a network, according to some embodiments of the present inventive concept.

FIGS. 2 to 5 illustrate various functionalities of application test cases, according to some embodiments of the present inventive concept.

FIG. 6 is a flowchart of operations for testing an application under regression test, according to some embodiments of the present inventive concept.

FIG. 7 is a flowchart of operations for testing an application, according to some embodiments of the present inventive concept.

FIG. 8 is a directed functional state interface mapping, according to some embodiments of the present inventive concept.

FIGS. 9 to 20 are flowcharts that illustrate operations for executing test cases on an application, according to some embodiments of the present inventive concept.

FIG. 21 is a block diagram of an electronic device configured according to some embodiments of the present inventive concept.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

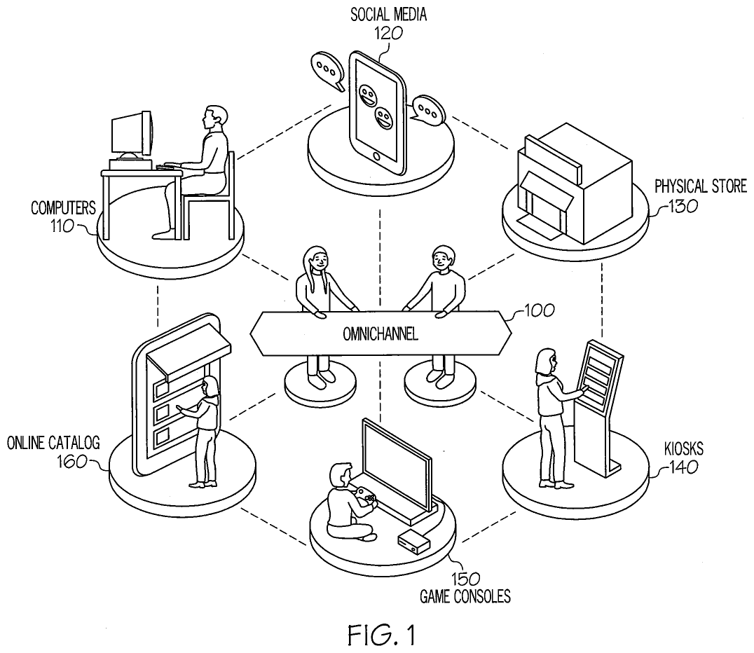

Businesses, companies, organizations, and/or groups use applications or web portals as an interface to users. Ubiquitous availability of computers, connected devices, and/or mobile devices provide access to most persons worldwide to connect to the Internet and access services, applications, and/or websites associated with businesses, companies, organizations, and/or groups. FIG. 1 illustrates an omni-channel communication network for providing services, applications, and/or websites over a network. An omni-channel communication network provides multiple access points to an application. As used herein, the term “applications” may refer to services, applications, websites, or other platform accessible by users. Referring to FIG. 1, various applications may be accessed through omni-channels 100. Service providers may provide applications/services on multiple channels with multiple interfaces such as REST API, GUI, mobile, web services, SDK, Java, Perl, etc. to support communication with applications/services. Applications may be accessed by omni-channels 100 through computers 110, social media applications 120, physical stores 130, kiosks 140, game consoles 150, and/or online catalogs 160. Application developers may need to run various test cases to test each of the interfaces to these different channels. An application may include various functionalities that each may have multiple interfaces. Functionalities may be modules or steps in running the application.

Various embodiments described herein may arise from the recognition that maintenance and execution of separate test suites or groups of test cases for each application interface within each functionality may be laborious, time consuming, and processor intensive. A large number of test cases may need to be executed to test various interfaces across various functionalities of an application. Techniques such as machine learning and artificial intelligence may be applied to regression testing environments to improve the speed and execution of regression test cases. Embodiments described herein will reduce the number of test case executions by identifying functionalities that have not been modified and selecting a single interface for executing the test case for the functionalities that have not been modified. An application may use as input, the context including the change in functionality and the interface impacted and then auto select the interface channel for execution of the actual test using an optimized channel for functionalities that have not changed.

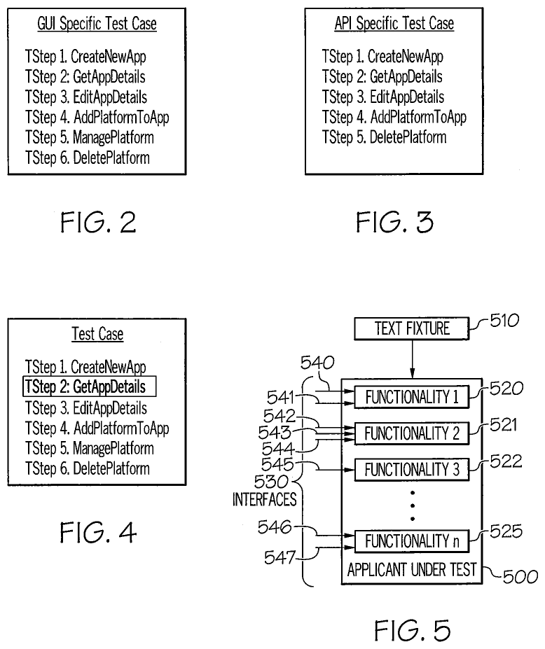

A test case may include a sequence of one or more functionalities/steps. Each step may be preconfigured or hard-coded to execute using a specific interface. FIG. 2 illustrates various functionalities or steps of an example GUI specific test case for testing an application. The GUI specific test case may include six functionalities or steps, TStep1 to TStep6. These functionalities may include CreateNewApp, GetAppDetails, EditAddDetails, AddPlatformToApp, ManagePlatform, and DeletePlatform. FIG. 3 illustrates various functionalities or steps of an API specific test case for testing an application. The API specific test case may include six functionalities or steps, TStep1 to TStep5. The API specific test case may not include the ManagePlatform functionality.

FIG. 4 illustrates various functionalities or steps of a test case for testing an application including functionality TStep2, GetAppDetails, which has been changed since previous execution of the test case. Changes to GetAppDetails may trigger regression test execution to ensure that an application performs properly after modifications to portions of the application. Regression test execution in some systems may execute the application interface suites irrespective of interface touch points in the code associated with the changed functionality, resulting in a large test execution time with repeated test coverage across various interfaces. These interfaces may be associated with various devices such as mobile terminals or access channels of FIG. 1 such as social media 120, kiosk 140, etc. Automated regression testing may be tasked with finding major application issues resulting from changes to functionality quickly. However, a long execution time for regression testing may not be suitable when problems in an application need to be corrected and tested quickly.

A test case that is run for regression may test an application that includes (1) pre-requisite test steps for entering the test step/functionality that is under test, (2) a test step that has been changed from a previous execution of the test case, and/or (3) post-requisite test steps that are executed after the test step/functionality that is under test has been executed. Still referring to FIG. 4, CreateNewApp may be a pre-requisite test functionality. GetAppDetails functionality has been changed and is thus under test. EditAddDetails, AddPlatformToApp, ManagePlatform, and DeletePlatform may be post-requisite test functionalities.

FIG. 5 is an application under test, according to various embodiments described herein. Application 500 that is under test may include functionalities 520 to 525 that are tested by a test fixture 510. The test fixture 510 may include various test cases that are run to test changes to functionalities 520 to 525. Each of functionalities 520 to 525 may have one or more associated interfaces 530. Each of the functionalities may have a different number of interfaces, such as interfaces 540 to 547.

Still referring to FIG. 5, a non-limiting example, such as the example discussed with respect to FIG. 4, may be mapped to application 500. Application 500 may have functionality 521 that has changed and is thus under test. Functionality 521 may have been modified and may thus provide functional impact resulting from code changes. Functionality 521 may have three interfaces 542, 543, and 544. Each of these three interfaces may be tested since the functionality 521 may depend upon interfaces 542, 543, and 544. Functionality 520 may be a pre-requisite test functionality with two interfaces 540 and 541. According to various embodiments described herein, to improve the speed of testing and reduce the number of test iterations, one of interfaces 540 or 541 may be selected for executing pre-requisite functionality 520 when testing application 500. Similarly, post-requisite functionality 525 may have two interfaces 546 and 547. Interfaces for functionality related to untouched code may be dynamically classified as pre-requisite or post-requisite test steps in a test case execution. One of interfaces 546 or 547 may be selected for executing post-requisite functionality 525 when testing application 500. For example, if interface 543 and 547 are dynamically selected during testing, iterations related to 542, 544, and 546 are not executed during testing, thus reducing the number of test executions by test fixture 510.

Dynamic selection of pre-requisite test and post-requisite test step interfaces may be based on attributes such as usage analytics of the interface, reliability of the interface, and/or performance analytics of the test interface over a period of time. Usage analytics may be related to which interfaces are used more extensively, i.e. a percentage of the accesses for which a specific interface is used by customers of the application. The reliability of an interface may be considered during dynamic interface selection to reduce troubleshooting efforts for functionalities unrelated to the modified functionalities under test. Error prone interfaces, such as ones that depend on third party applications like browsers that may hang on loading or elements not being found, may be avoided. Performance analytics of the test interface over a period of time may be considered during dynamic interface selection and may be based on speed of execution of the functionality when using an interface, measure of the portions of functionality that are exercised by the interface, and/or variability of speed of execution. Interfaces that may include time consuming operations, such as page loading, page navigations, etc. may be avoided.

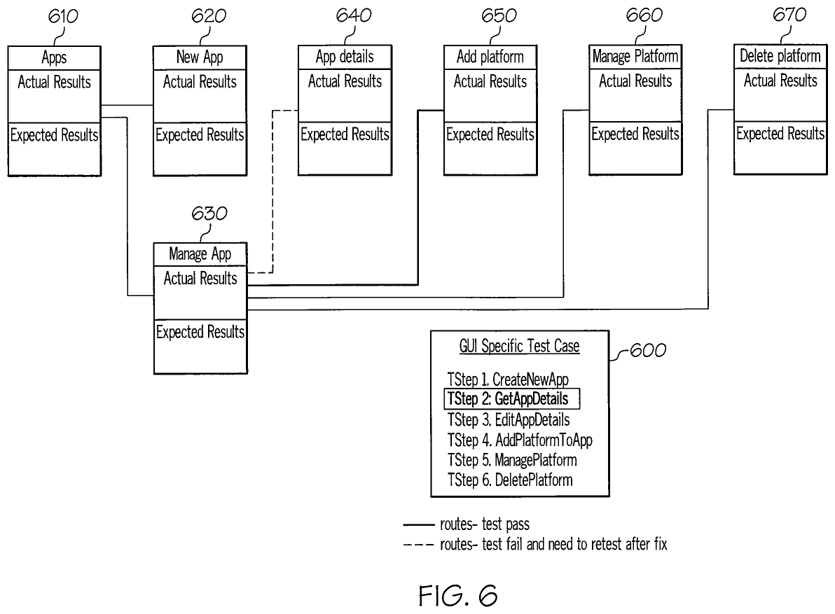

FIG. 6 illustrates a sample functional flow chart of an application under regression test. Referring to FIG. 6, an application 610 may call a new application 620 and manage application 630 that has been changed or modified. A test case where the application details 640 functionality is executed after the manage application 630 may cause a test failure and may require a retest after fixing manage application 630. The execution of manage application 630 may have flows that execute add platform 650, manage platform 660, or delete platform 670. The paths to add platform 650, manage platform 660, or delete platform 670 may have passed the test cases and thus not need retesting upon code changes to manage app 630. According to various embodiments described herein, subsequent testing runs may concentrate testing on manage app 630 by reducing the number of interfaces that are tested for add platform 650, manage platform 660, and/or delete platform 670.

A non-limiting working example with respect to FIG. 6 will now be described. The functionality GetAppDetails may have failed. The reason for failure of GetAppDetails may be determined to be specific to GUI interface. A correction or fix may be made in code related to the GUI interface of GetAppDetails. The regression tests may include GUI specific test case 600 that has multiple test steps. Since the fix is made for GetAppDetails, the step/functionality of GetAppDetails may be referred to as the “test functionality” with CreateNewApp as a pre-requisite test step/functionality and the remaining test steps being post-requisite test steps. The pre-requisite and post-requisite steps may each have implementations using a REST interface, a SDK interface, and a mobile interface. Executing all six test steps in GUI specific test case 600 may be time consuming compared to execution using one of REST interface, SDK interface, or the mobile interface based on the past history of attributes such as usage ranking, performance, and reliability of the interface. Based on historical data, the REST interface may be more reliable, faster, and be used mostly from various user channels. Therefore, according to various embodiments discussed herein, the GetAppDetails test step/functionality will be executed in GUI, since it has been modified, and the remaining test steps/functionalities are executed using the REST Interface. If the pre-requisite test step CreateApp is ranked as most commonly used from the GUI interface, the CreateApp functionality may be executed with the GUI interface instead of REST interface. Therefore, each test step/functionality is optimized during testing based on the current context, i.e. change in functionality and the interface impacted.

Another non-limiting working example with respect to FIG. 6 will now be described. The functionality GetAppDetails may have failed. The reason for failure of GetAppDetails may be determined to be in a common function used by all of the interfaces of GetAppDetails. In other words, the context is determined to be that the fix for this problem impacts all interfaces. Once the fix is completed, regression test cases are distributed to execute the test step/functionality GetAppDetails with multiple interfaces, since the multiple interfaces have been affected. For each of the pre-requisite and post-requisite test step/functionality executions, one interface may be selected based on the attributes such as ranking by usage, the performance and reliability of the interface. Optimization of the test execution is thus based on the current context, i.e. interfaces impacted. Assuming 9 regression test cases, in a non-optimized scenario, if each of the functionalities has three interfaces and all interfaces are tested for the three interfaces that have changed of affected in GetAppDetails, 27 executions may be necessary. If a reduced or optimized regression test methodology, as described herein, is used, then the 9 test cases will be run across the 3 changed interfaces in GetAppDetails, and a single interface may be selected for each test case for the pre-requisite and post-requisite test step/functionality executions. Thus the number of test case executions is 9, significantly reducing the processing of the number of test cases and the overall time to complete regression testing.

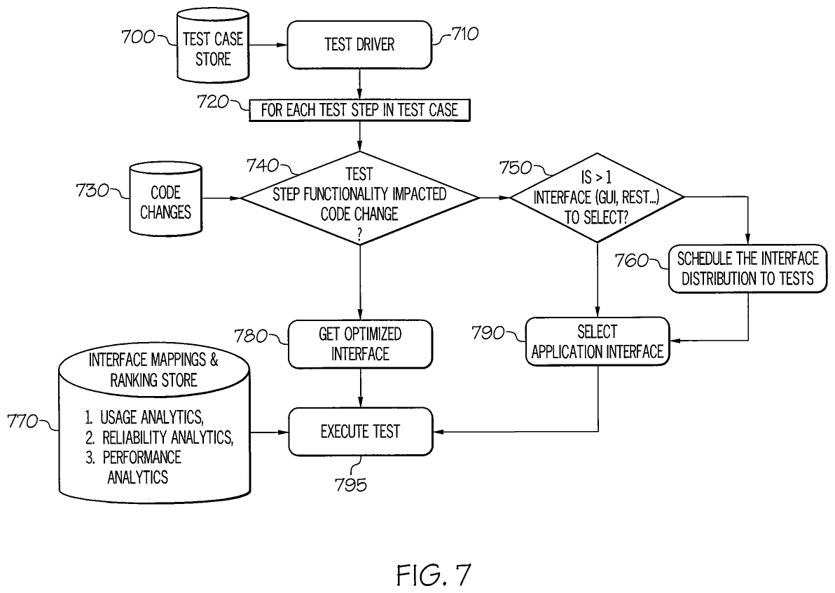

FIG. 7 is a flowchart of operations for testing an application, according to various embodiments described herein. Referring now to FIG. 7, test cases may be stored in a test case store 700 such as a database, memory, and/or server. A test driver may be executed at block 710. Execution may occur for each test step in the test case at block 720. Code changes may be stored using a code management tool and/or be identified by defect management tools, at block 730. A check may be performed to determine if test step functionality for a given functionality is impacted by the code change at block 740. If the functionality is not impacted by the code change, then an optimized interface may be selected, at block 780. If the functionality is impacted by the code change, a determination is made as to whether more than one interface such as a GUI, REST, etc. is present, at block 750. If more than one interface is available in a modified functionality, the various interfaces may be scheduled for test execution, at block 760. The application interface may be selected at block 790. The test case may be executed at block 795.

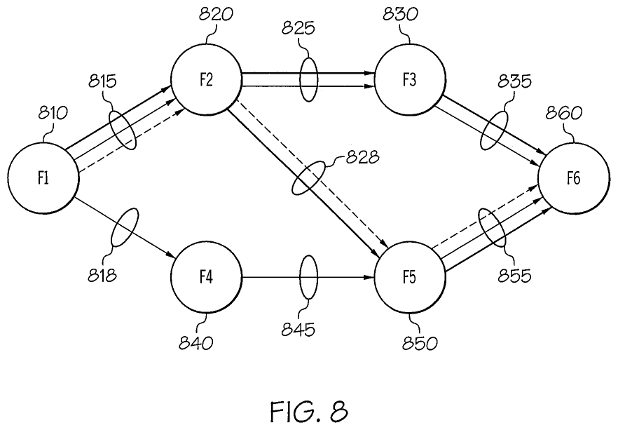

FIG. 8 is a directed functional state interface mapping diagram. The directed graph of FIG. 8 includes vertices and edges that may be used to determine the selection of testing interfaces as described by various embodiments herein. The directed graph may be maintained in a file system and fetched when an interface needs to be selected. Referring to FIG. 8, the vertices of the graph include nodes 810, 820, 830, 840, 850, and 860 that represent the states of the application and thus may maintain the functional state of each of the functionalities of FIGS. 4 and/or 5 during execution of the application. In other words, the nodes of the directed graph of FIG. 8 may represent the current point during the execution of the application. The edges of the directed graph of FIG. 8 may be referred to as arrows, directed edges, or directed lines. The edge may denote an interface that moves the execution from one functional state to another. A transition may include multiple directed edges in the directed graph of FIG. 8. The transitions of the directed graph may each include one or more edges that represent various interfaces. For example, transition 815 may represent functionality CreateNewApp of FIG. 4 and include three edges that represent three interfaces such as the Java SDK API, C SDK API, and WSDL or UI interface. Transition 825 may represent functionality DeletePlatform of FIG. 4 and include two edges that represent two interfaces.

In order to select an interface out of the transition, weights may be determined for each of the edges in a transition to quantify potential suitability of each interface. The weight of the edge may be based on various attributes such as performance, scalability, and/or reliability. A ranking may be determined for the interfaces, based on the respective weights of the edges. To determine ranking based on weights of the edges, one or more attributes may be quantified across the various edges. The weights of these attributes may be added together for a given edge. The sum of the weights of the attributes for each of the edges may be used to rank the edges. Selection of the interface may be based, for example, on selecting the edge with the highest sum of the weights of the attributes. In some embodiments, different attributes may have different contribution factors such that specific attributes may have greater mathematical consideration than other attributes.

Still referring to FIG. 8, a non-limiting example is now discussed. The transition 815 for CreateNewApp may have three interfaces: Java SDK API, C SDK API, and WSDL. Scalability of the interface may be based on the real time usage of the interface during real world execution of the application. For example, the WSDL interface may be used 60%, the Java interface may be used 30%, and the C SDK interface may be used 10% of the executions. These percentages may be used as weights for determining the interface. In some embodiments, the scalability or usage of the interface may be used to determine the selection of the interface. In this case, the WSDL interface may be selected since the weighting would be 0.6 in this example. In some embodiments, weights of three attributes such as the scalability, performance, and reliability may be considered in selecting the interface. For example, if the Java interface operates significantly faster than the other interfaces, a performance weight of 0.7 for the Java interface, 0.2 for WDSL interface, and 0.1 for the C SDK interface may be considered. Regarding the reliability attribute, if the Java and C SDK interfaces are more reliable than the WSDL interface, a performance weight of 0.45 may be considered for each of the Java and C SDK interfaces and 0.1 for the WSDL interface. In this case, the total weight of the edges are (0.6+0.2+0.1)=0.9 for the WSDL interface, (0.3+0.7+0.45)=1.45 for the Java interface and (0.1+0.1+0.45)=0.65 for the C SDK interface. In this case, the Java interface may be selected for executing CreateNewApp, since the Java interface has the highest weighting. In some embodiments, a scaling factor may be applied to one or more of the attribute weightings to provide emphasis for specific attributes.

FIG. 9 is a flowchart that illustrates operations for executing test cases on an application, using techniques described with respect to FIG. 6 to FIG. 8. Referring to FIG. 9, the operations include identifying a first interface associated with a first functionality of a plurality of functionalities of an application, at block 910. A portion of the first functionality has changed within the application. Operations include identifying a second functionality of the plurality of functionalities of the application that has not changed, at block 920. The second functionality may be associated with a plurality of second interfaces. Operations include selecting a testing interface out of the plurality of second interfaces associated with the second functionality, at block 930. Operations include executing a test case for testing the application using the first interface associated with the first functionality and using the testing interface associated with the second functionality, but refraining from using remaining ones of the plurality of second interfaces associated with the second functionality for executing the test case, at block 940.

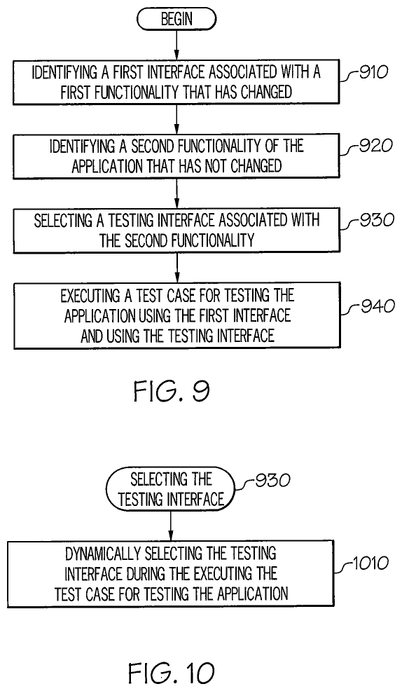

FIG. 10 is a flowchart that illustrates operations for executing test cases on an application. Referring to FIG. 10, selecting the testing interface, at block 930, may include dynamically selecting the testing interface during the executing the test case for testing the application, at block 1010. Dynamic selection of interfaces may entail test execution time (i.e. runtime) decisions of which interfaces to use for various pre-requisite and post-requisite functionalities.

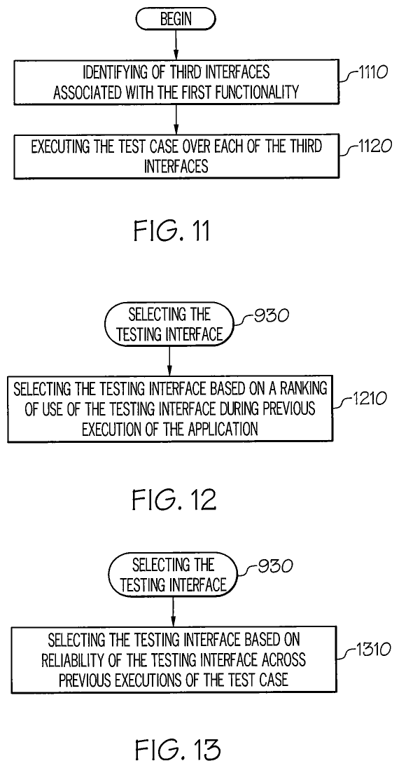

FIG. 11 is a flowchart that illustrates operations for executing test cases on an application. Referring to FIG. 11, the operations may include identifying a plurality of third interfaces associated with the first functionality at block 1110. The test case may be executed over each of the plurality of the third interfaces at block 1120.

FIG. 12 is a flowchart that illustrates operations for executing test cases on an application. Referring to FIG. 12, selecting the testing interface out of the plurality of second interfaces associated with the second functionality, at block 930, may include selecting the testing interface based on a ranking of use of the testing interface during previous execution of the application, at block 1210. Ranking the use of the testing interface may include determining a percentage of the application's accesses via a specific interface.

FIG. 13 is a flowchart that illustrates operations for executing test cases on an application. Referring to FIG. 13, selecting the testing interface out of the plurality of second interfaces associated with the second functionality, at block 930, may include selecting the testing interface based on reliability of the testing interface across a plurality of previous executions of the test case at block 1310. Reliability of an interface may be based on a failure rate of the functionality when using the interface.

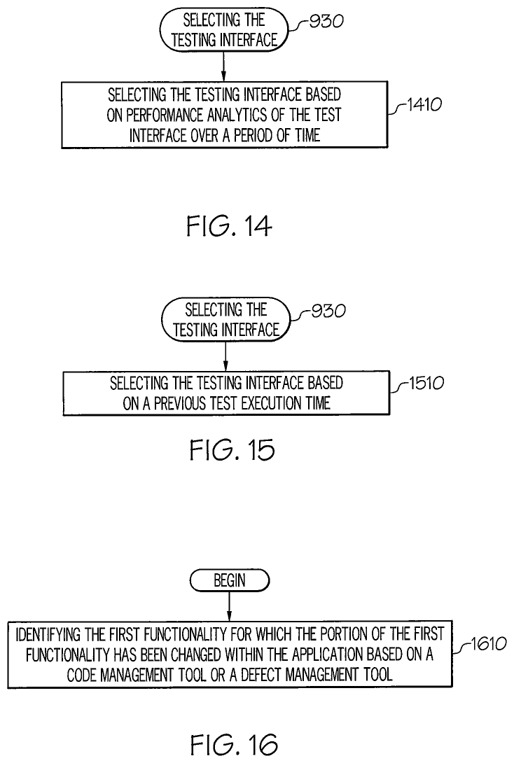

FIG. 14 is a flowchart that illustrates operations for executing test cases on an application. Referring to FIG. 14, selecting the testing interface out of the plurality of second interfaces associated with the second functionality, at block 930, may include selecting the testing interface based on performance analytics of the test interface over a period of time, at block 1410. Performance analytics may be based on the speed of execution of the functionality using a specific interface.

FIG. 15 is a flowchart that illustrates operations for executing test cases on an application. Referring to FIG. 15, selecting the testing interface out of the plurality of second interfaces associated with the second functionality, at block 930, may include selecting the testing interface based on a previous test execution time at block 1510.

FIG. 16 is a flowchart that illustrates operations for executing test cases on an application. Referring to FIG. 16, the first functionality for which the portion of the first functionality has been changed may be identified within the application based on a code management tool or a defect management tool at block 1610. The code management tool may be used by developers to check-in code changes to modify/fix the functionality. A defect management tool may be used to track defects or change requests and may be used to identify functionalities that have been changed.

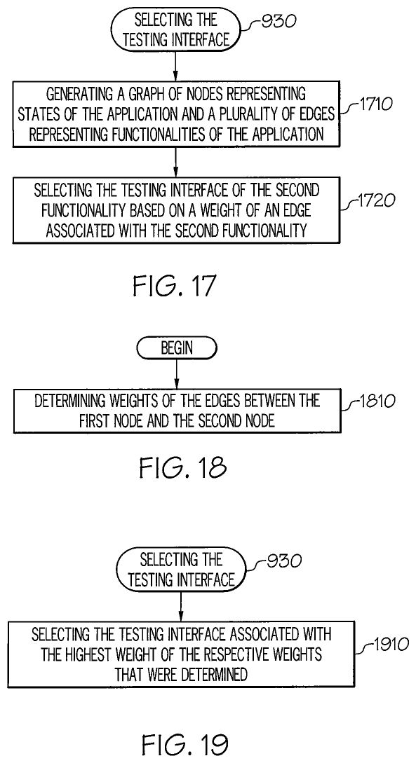

FIG. 17 is a flowchart that illustrates operations for executing test cases on an application. Referring to FIG. 17, selecting the testing interface out of the plurality of second interfaces associated with the second functionality, at block 930, may include generating a graph comprising a plurality of nodes representing respective states of the application and a plurality of edges representing respective ones of the plurality of functionalities of the application at block 1710. The testing interface of the second functionality may be selected based on a weight of an edge associated with the second functionality, at block 1710.

FIG. 18 is a flowchart that illustrates operations for executing test cases on an application, such as those discussed with respect to FIG. 8. Referring to FIG. 18, respective weights of respective ones of the plurality of edges between the first node and the second node may be determined at block 1810.

FIG. 19 is a flowchart that illustrates operations for executing test cases on an application. Referring to FIG. 19, selecting the testing interface of the second functionality, at block 930, may include selecting the testing interface associated with the highest weight of the respective weights that were determined at block 1910. A first weight of the respective weights may be based on a sum of respective contribution factors associated with respective ones of a plurality of attributes. The attributes considered in selecting the interface may include performance, scalability, and/or reliability.

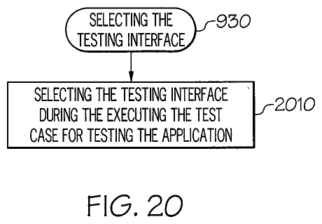

FIG. 20 is a flowchart that illustrates operations for executing test cases on an application. Referring to FIG. 20, selecting the testing interface of the second functionality based on the weight of an edge associated with the second functionality, at block 930, may include selecting the testing interface during the executing the test case for testing the application at block 2010.

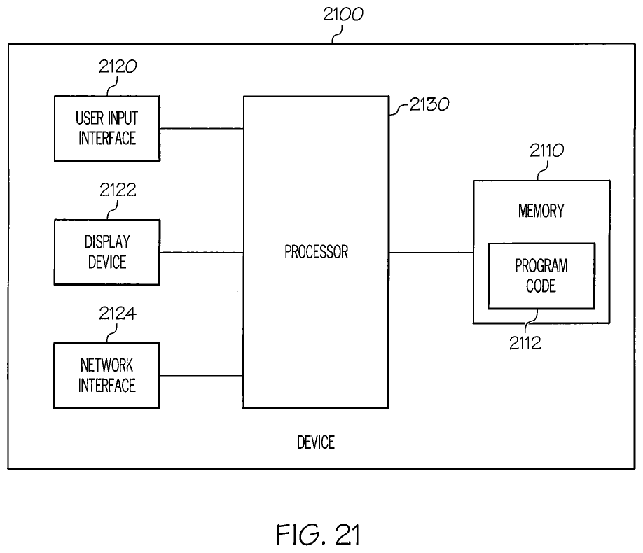

FIG. 21 is a block diagram of an electronic device 2100 configured according to some embodiments. The electronic device 2100 may include the channel access devices such as the computers 110, social media applications 120, physical stores 130, kiosks 140, game consoles 150, and/or online catalogs 160 FIG. 1. In some embodiments, the electronic device 2100 may be integrated with the channel access devices or be standalone devices. Referring to FIG. 21, the electronic device 2100 includes a processor 2130, a memory 2110, and a network interface 2124 which may include a radio access network transceiver and/or a wired network interface (e.g., Ethernet interface). The radio access network transceiver can include, but is not limited to, a LTE or other cellular transceiver, WLAN transceiver (IEEE 802.11), WiMax transceiver, or other radio communication transceiver configured to communicate with a service provider network or data center operator, such as network operator device 130 of FIG. 1.

The processor 2130 may include one or more data processing circuits, such as a general purpose and/or special purpose processor (e.g., microprocessor and/or digital signal processor) that may be collocated or distributed across one or more networks. The processor 2130 is configured to execute computer program code 2112 in the memory 2110, described as a non-transitory computer readable medium, to perform at least some of the operations described herein as being performed by an electronic device. The computer program code 2112 when executed by the processor 2130 causes the processor 2130 to perform operations in accordance with one or more embodiments disclosed herein for the electronic device 2100. The electronic device 2100 may further include a user input interface 2120 (e.g., touch screen, keyboard, keypad, mouse, etc.) and/or a display device 2122.

Various embodiments described herein have used techniques based on machine learning and artificial intelligence to improve the speed and processing needed for regression testing of applications. Based on the techniques described herein, an application regression test suite may be independent of application interfaces without hardcoding interfaces for each test step/functionality. Interface selection may occur based on determination of touched and untouched modules/code points. Thus rapid verification of modifications to an application using limited interfaces for test execution is achieved.

Further Definitions and Embodiments:

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, JavaScript, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions, when stored in the computer readable medium, produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive subject matter.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described to best explain the principles of the disclosure and the practical application, and to enable others of ordinary skill in the art to understand the disclosure with various modifications as are suited to the particular use contemplated.

1. A method comprising:
performing operations as follows on a processor:
identifying a first interface associated with a first functionality of a plurality of functionalities of an application, wherein a portion of the first functionality has changed within the application;
identifying a second functionality of the plurality of functionalities of the application that has not changed, wherein the second functionality is associated with a plurality of second interfaces;
generating a graph comprising a plurality of nodes representing respective states of the application and a plurality of edges representing respective ones of the plurality of functionalities of the application;
selecting a testing interface out of the plurality of second interfaces associated with the second functionality based on a weight of an edge associated with the second functionality; and
executing a test case for testing the application using the first interface associated with the first functionality and using the testing interface associated with the second functionality, but refraining from using remaining ones of the plurality of second interfaces associated with the second functionality for executing the test case,
wherein a transition between a first node and a second node of the plurality of nodes is associated with the second functionality, and
wherein the transition comprises a plurality of edges associated with respective ones of the plurality of second interfaces associated with the second functionality.

2. The method of claim 1, wherein the selecting the testing interface comprises:
dynamically selecting the testing interface during the executing the test case for testing the application.

3. The method of claim 1, further comprising:
identifying a plurality of third interfaces associated with the first functionality; and
executing the test case over each of the plurality of the third interfaces.

4. The method of claim 1, wherein the selecting the testing interface out of the plurality of second interfaces associated with the second functionality comprises:
selecting the testing interface based on a ranking of use of the testing interface during previous execution of the application.

5. The method of claim 1, wherein the selecting the testing interface out of the plurality of second interfaces associated with the second functionality comprises:
selecting the testing interface based on reliability of the testing interface across a plurality of previous executions of the test case.

6. The method of claim 1, wherein the selecting the testing interface out of the plurality of second interfaces associated with the second functionality comprises:
selecting the testing interface based on performance analytics of the test interface over a period of time.

7. The method of claim 1, wherein the selecting the testing interface out of the plurality of second interfaces associated with the second functionality comprises:
selecting the testing interface based on a previous test execution time.

8. The method of claim 1, further comprising:
identifying the first functionality for which the portion of the first functionality has been changed within the application based on a code management tool or a defect management tool.

9. (canceled)

10. (canceled)

11. The method of claim 1, further comprising:
determining respective weights of respective ones of the plurality of edges between the first node and the second node.

12. The method of claim 11, wherein the selecting the testing interface of the second functionality comprises:
selecting the testing interface associated with a highest weight of the respective weights that were determined.

13. The method of claim 11, wherein a first weight of the respective weights comprises a sum of respective contribution factors associated with respective ones of a plurality of attributes.

14. The method of claim 13, wherein the plurality of attributes comprises performance, scalability, and reliability.

15. The method of claim 1, wherein the selecting the testing interface out of the plurality of second interfaces associated with the second functionality based on the weight of the edge associated with the second functionality comprises:
selecting the testing interface during the executing the test case for testing the application.

16. A computer program product, comprising:
a tangible, non-transitory computer readable storage medium comprising computer readable program code embodied therein, the computer readable program code comprising:
computer readable code to identify a first interface associated with a first functionality of a plurality of functionalities of an application, wherein a portion of the first functionality has changed within the application;
computer readable code to identify a second functionality of the plurality of functionalities of the application that has not changed, wherein the second functionality is associated with a plurality of second interfaces, wherein a transition between a first node and a second node of a plurality of nodes is associated with the second functionality and wherein the transition comprises a plurality of edges associated with respective ones of the plurality of second interfaces associated with the second functionality;
computer readable code to determine respective weights of respective ones of the plurality of edges between the first node and the second node;
computer readable code to select a testing interface out of the plurality of second interfaces associated with the second functionality based on a highest weight of the respective weights that were determined; and
computer readable code to execute a test case for testing the application using the first interface associated with the first functionality and using the testing interface associated with the second functionality, but refraining from using remaining ones of the plurality of second interfaces associated with the second functionality for executing the test case.

17. The computer program product of claim 16, further comprising:
computer readable code to dynamically select the testing interface during the executing the test case for testing the application.

18. The computer program product of claim 16, further comprising:
computer readable code to generate a graph comprising a plurality of nodes representing respective states of the application and a plurality of edges representing respective ones of the plurality of functionalities of the application; and
computer readable code to select the testing interface of the second functionality based on a weight of an edge associated with the second functionality.

19. (canceled)

20. A computer system, comprising:
a processor; and
a memory coupled to the processor, the memory comprising computer readable program code embodied therein that, when executed by the processor, causes the processor to perform operations comprising:
identifying a first interface associated with a first functionality of a plurality of functionalities of an application, wherein a portion of the first functionality has changed within the application;
identifying a second functionality of the plurality of functionalities of the application that has not changed, wherein the second functionality is associated with a plurality of second interfaces;
generating a graph comprising a plurality of nodes representing respective states of the application and a plurality of edges representing respective ones of the plurality of functionalities of the application;
selecting a testing interface out of the plurality of second interfaces associated with the second functionality based on a weight of an edge associated with the second functionality; and
executing a test case for testing the application using the first interface associated with the first functionality and using the testing interface associated with the second functionality, but refraining from using remaining ones of the plurality of second interfaces associated with the second functionality for executing the test case,
wherein a transition between a first node and a second node of the plurality of nodes is associated with the second functionality, and
wherein the transition comprises a plurality of edges associated with respective ones of the plurality of second interfaces associated with the second functionality.
